(19) United States
(12) Patent Application Publication
(10) Pub. No.: US 2010/0127128 A1
(43) Pub. Date: May 27, 2010

(54) DEVICE FOR MOUNTING NON-DIMENSIONING EQUIPMENT ON THE STRUCTURAL FRAME OF A VEHICLE, VEHICLE FITTED WITH SUCH DEVICE AND MOUNTING METHOD

(75) Inventor: Jean-Paul Giavarini, Castelnau D'Estretefonds (FR)

Correspondence Address: YOUNG & THOMPSON, 209 Madison Street, Suite 500, Alexandria, VA, 22314, US

(73) Assignee: SOGECLAIR, BLAGNAC (FR)

(21) Appl. No.: 12/528,063

(22) PCT Filed: Feb. 18, 2008
(86) PCT No.: PCT/FR2008/000208

§ 371 Date: Aug. 20, 2009

(30) Foreign Application Priority Data
Feb. 21, 2007 (FR) 0701231

(51) Int. Cl. B64C 1/06; B23P 17/04; B60R 11/00

(52) U.S. Cl. 244/131; 29/525.01; 224/570

(57) ABSTRACT

A device for mounting non-dimensioning equipment (5) on the structural frame (1) of a vehicle, that includes a plurality of fixings (6) for at least one piece of equipment (5), wherein it includes a plurality of fixing holders (4) bearing at least one fixing (6); a rigid intermediate frame (2) including a set of rigid assembling sites for at least one fixing holder (4); a plurality of rigid attachment clamps (3) for securing the intermediate frame (2) onto the structural frame (1), each attachment clamp (3) being rigidly anchored on the structural frame (1) and receiving at least one intermediate frame (2) portion and maintaining the same rigidly in order to prevent any undesired movement of the intermediate frame (2) portion relative to the structural frame (1). A vehicle equipped with such a mounting device and a method for mounting the mounting device are also described.

The invention relates to a device for mounting non-dimensioning equipment—in particular electrical, hydraulic, pneumatic equipment, etc.—on a structural frame of a vehicle—aircraft, high-speed train, submarine, etc.

Numerous vehicles, in particular motorized vehicles, are constructed from a rigid structure formed from rigid members such as beams (side rails, ribs, crossmembers, uprights, etc.) small beams, stiffeners, arches, frames, stringers, plates, body or shell portions assembled to one another, etc., which defines the overall shape of the vehicle. This structure is capable of resisting the stresses to which the vehicle may be subjected and of carrying its various practical functional members (engine type, service equipment, control units, useful loads, payloads, accessories, etc.).

Within the entire text, this structure is denoted by the term “structural frame”. Such a structural frame is referred to differently according to the type of vehicle; it refers to the chassis of a road or rail vehicle, the airframe of an aircraft, the hull of a boat, etc.

A motorized vehicle is, moreover, provided with at least one network for the distribution of energy and/or fluid(s) formed by different equipment (cables, tubes, pipes, sheaths, fixing holders, commutators, transmissions, distributors, etc.) which have to be fixed to the structural frame.

The structural frames of a large number of vehicles, in particular motorized vehicles, and more particularly the airframes of aircraft and the chassis of high-speed trains, are optimized in terms of weight and mechanical strength—in particular under fatigue. This optimization of the frames consists in determining the best compromise of weight/strength so as to optimize the performance and to limit the consumption of energy during the use of the vehicle, whilst ensuring sufficient strength which is able to withstand the different forces to which the vehicle may be subjected during use.

The dimensioning of a structural frame of a vehicle takes into account the critical loads of the vehicle which it is intended to receive, i.e. the loads, including the weight and forces which they exert on the structural frame, determine the definition and the dimensioning of the structural frame. For an aircraft, for example, this refers to the engines, the landing gear, the mass and the distribution of the mass of the payload (passengers, freight), etc.

However, the definition and dimensioning of a structural frame do not take into account the non-critical loads, i.e. the loads of which the impacts are negligible within the scope of the definition and the dimensioning of the structural frame. Some of these non-critical loads are due to equipment, denoted within the entire text by the expression (“non-dimensioning equipment”). They refer, in particular, to network equipment (electrical cables, air ducts, etc.).

Machining operations such as drilling carried out in a structural frame of the vehicle designed to permit the support of equipment, including non-dimensioning equipment, are likely to modify the mechanical properties of the structural frame.

Thus, when defining and dimensioning a structural frame of a vehicle, it is appropriate to take into account the machining—in particular the drilling—intended to receive the equipment supports, including the supports for non-dimensioning equipment for this structural frame.

As a result, a structural frame is optimized for a given configuration of the equipment, including non-dimensioning equipment having to be joined to this structural frame.

In other words, each structural frame is designed to receive a set of pre-determined pieces of equipment. Any modification to the configuration requires a modification to the structural frame of the vehicle, making difficult the economical manufacture of the structural frames of the vehicle.

For example, within the aeronautical field, each airline has its own requirements in terms of electrical equipment. More specifically, the arrangement of the electrical system of an aircraft required by one airline is not necessarily compatible with the arrangement of the electrical system required by a different airline. Moreover, the arrangement of the electrical system required by one airline may require certain features of the structural frame of the aircraft which do not permit the arrangement of the electrical system required by a different airline.

As a result, each configuration of equipment, including non-dimensioning equipment for an aircraft airframe, requires the adaptation of the structure of the airframe of the aircraft to this configuration, by carrying out machining capable of allowing the fixing of this equipment.

Nowadays, the process of manufacturing a vehicle, and more particularly an aircraft, starts in an engineering and design department by developing one or more virtual model(s) to be completed at the assembling sites. A virtual model defines the machining necessary for mounting the pre-determined equipment. This mounting is then carried out at the assembling sites. Any modification to the configuration of the equipment requires redefining the virtual model, i.e. requires a return to the design of the structural frame in terms of the virtual model. More specifically, such a modification may take place at a very advanced stage of the manufacturing process, in particular at the time of assembly in the factory which may lead to a considerable loss of time. As a result there is a substantial increase in the design cost of the aircraft.

This drawback is exacerbated by the increase in entertainment systems on board commercial aircraft. In particular, this increase has led to a rise in the number of types of electrical equipment, such as cables, fixing holders, circuit breakers, etc., to be housed in the aircraft. More specifically, each piece of equipment has to be rigidly connected—directly or indirectly—to the airframe of the aircraft so that said equipment follows the movement of the aircraft. This requires creating fixing points in the airframe of the vehicle which may receive the equipment or a support for the equipment. More specifically, as indicated above, the machining to be carried out to fix the equipment leads to a modification of the mechanical properties of the aircraft, which is not always acceptable.

As a result, any modification to the specifications during the manufacture of an aircraft, including modifications associated with non-dimensioning equipment, such as the electrical system or the air conditioning system, leads to a substantial reappraisal of the aircraft.

The object of the invention is to remedy this drawback and to propose a device for mounting, relative to the structural frame of the vehicle, non-dimensioning equipment (i.e. equipment of which the weight is not taken into account during the design of the structural frame of the vehicle), which makes it possible to produce any type of configuration from the same structural frame of the vehicle, without requiring any modification—in particular machining or reinforcements—on the structural frame of the vehicle.

The object of the invention, in particular, is to provide a device for mounting equipment of at least one network, such as an electrical network, a pneumatic network or a hydraulic network, on the structural frame of a vehicle, which makes it possible to remedy the aforementioned problems.

The object of the invention is also to provide a device for mounting equipment which makes it possible to modify the arrangement of the equipment on the frame of a vehicle, without requiring the modification of the structural frame.

The object of the invention is also to provide a device for mounting modular equipment.

The object of the invention is also to provide an economical device for mounting equipment.

The object of the invention is also to provide a device for mounting equipment of which the installation on the frame of the vehicle is simplified.

The object of the invention is also to provide a vehicle comprising a structural frame fitted with a mounting device according to the invention.

The object of the invention is also to provide a method for mounting equipment on a vehicle frame.

To achieve this, the invention relates to a device for mounting non-dimensioning equipment on the structural frame of a vehicle comprising:
a plurality of fixings for at least one piece of non-dimensioning equipment, each fixing being capable of receiving and maintaining at least one portion of non-dimensioning equipment, wherein it comprises:
a rigid intermediate frame comprising a plurality of rigid assembling sites for at least one fixing holder on said intermediate frame,
a plurality of fixing holders bearing at least one fixing and comprising a resilient clip capable of permitting the fixing of said fixing holder to said intermediate frame at any one of the rigid assembling sites,
a plurality of rigid attachment clamps for securing said intermediate frame onto said structural frame of the vehicle, each attachment clamp being rigidly anchored on the structural frame and receiving at least one intermediate frame portion and maintaining the same rigidly in order to prevent any undesired movement of said intermediate frame portion relative to the structural frame.

A mounting device according to the invention thus makes it possible to have a plurality of fixings for network equipment borne by an intermediate frame. Each fixing for a piece of equipment is borne by a fixing holder, itself rigidly assembled to the intermediate frame at an assembling site, selected from a plurality of assembling sites. The flexibility of the mounting of equipment is associated with the number of separate assembling sites available on the intermediate frame. More specifically, according to the invention, the fixing holder comprises a resilient clip capable of being fixed to the intermediate frame at any one of the assembling sites, which makes it possible to modify without difficulty the arrangement of the fixing holders on the intermediate frame.

According to the prior art, the fixings of the non-dimensioning equipment, in particular equipment of a network, are directly borne by clamps fixed to the structural frame.

According to the invention, the attachment clamps anchored to the structural frame bear an intermediate frame which comprises a plurality of assembling sites permitting the fixing of equipment. As a result, a set of assembling sites according to the invention may correspond to a fixing point of the prior art.

A mounting device according to the invention provides an intermediate frame, which duplicates a part of the structural frame of the vehicle and which may, at first sight, be considered as an additional overload. In reality, the inventors have observed that the increase in the mass caused by a mounting device according to the invention is compensated by the lightening of the structural frame, said frame being able to be dimensioned very precisely according to the critical loads and, in particular, no longer requiring either overdimensioning or reinforcing of the structural frame to permit carrying out machining, in particular drilling.

A mounting device according to the invention eliminates all the requirements of additional machining not initially provided on the structural frame of the vehicle during its design. As a result, the structural frame of the vehicle preserves its original specifications, in particular in terms of strength, but allows different equipment to be mounted and thus has a high degree of flexibility when mounting in the factory. Thus, a mounting device according to the invention makes it possible in the factory to adapt to the practical constraints not taken into account during the design of the structural frame, in particular in the case of a design by means of a virtual model.

A mounting device according to the invention also permits a retrospective customization of the vehicle which does not require a reappraisal of the structural calculations.

In the case of aeronautical applications, a mounting device according to the invention provides the possibility to a manufacturer of adapting the electrical, hydraulic and pneumatic functions to the desires and needs of each airline. Moreover, henceforth it becomes possible to reuse at low cost an aircraft previously equipped according to a first configuration for a different application, without having to alter the airframe of the aircraft. It also becomes possible to reallocate at low cost an aircraft initially provided for one client according to a first configuration to a different client according to a different configuration.

In practice, advantageously and according to the invention, a structural vehicle frame comprises a plurality of fixing sites uniformly distributed over the entire structural frame of the vehicle, each fixing site being capable of receiving a rigid attachment clamp for the intermediate frame on the structural frame. As a result, the structural frame of the vehicle is designed and optimized to comprise an assembly of fixing sites uniformly distributed over the entire frame.

The uniform distribution of the fixing sites on the structural frame of the vehicle makes it possible to reduce, in particular, the drilling equipment required to produce these fixing sites. In particular, according to the techniques of the prior art, each configuration of the equipment is associated with a drilling jig which is predetermined and specific to this configuration. According to the invention, a drilling jig is adapted to the production of fixing sites for all types of configurations.

These fixing sites are formed by machining—in particular drilling or thread tapping—preferably carried out in the zones of least stress of the structural frame so as to minimize the impacts on the mechanical properties of the structure.

During the installation of the mounting device on the structural frame, the number of fixing sites to be used, amongst all the fixing sites available on the frame, and the choice of these sites, are determined and defined according to the mounting constraints of the equipment of a network and of the desired configuration for the network. It is no longer necessary to provide the number of fixing sites and the precise location thereof during the design of the structural frame of the vehicle. More specifically, the intermediate frame makes it possible to displace the rigid assembly points where necessary.

A device according to the invention, therefore, permits a flexibility of the development and of the positioning of non-dimensioning equipment and considerably simplifies the manufacture of the vehicle. It reduces the production time and the costs thereof without impairing its performance, even improving the performance.

A device according to the invention facilitates the installation of non-dimensioning equipment, in particular network equipment, on assembly lines and also the maintenance thereof.

An intermediate frame according to the invention may be formed from various elements borne by the attachment clamps and capable of rigidly receiving fixing holders bearing fixings capable of supporting equipment. An intermediate frame according to the invention may form the subject of various embodiments. It may comprise plates, grids, panels, metal plates, trusses, rods, tubes, cables, mesh, etc. borne by the attachment clamps and extending opposite the structural frame in one or more directions.

Advantageously and according to the invention, said intermediate frame comprises a plurality of rails for receiving said fixing holders, each receiving rail being capable of receiving rigidly, at any point of the rail, at least one fixing holder.

The combination of receiving rails and fixing holders having a resilient clip permits a fixing of each fixing holder at any point of the rail. A device according to the invention thus has an infinite number of assembling sites, which permits an infinite number of individual configurations starting from the same structural frame, provided with an intermediate frame.

A rail for receiving fixing holders is a rigid profiled part capable of permitting the fixing of supports for attaching to this rail.

A rail is easy to manufacture and handle, making the marketing and use thereof economical.

Moreover, an intermediate frame comprising rails for receiving fixing holders permits a wide variety of configurations capable of meeting the majority of requirements for the installation of non-dimensioning equipment such as network equipment.

An intermediate frame according to the invention may comprise rails and connecting parts, such as rings or equivalent means, to provide a rigid connection between a rail and a rigid attachment clamp for the intermediate frame on the structural frame.

However, advantageously and according to the invention, at least one attachment clamp—in particular each attachment clamp—comprises means for receiving at least one portion of at least one rail capable of receiving said rail and maintaining it rigidly in order to prevent any movement of said rail relative to the structural frame of said vehicle.

According to this embodiment, each attachment clamp anchored in the structural frame of the vehicle comprises means for receiving at least one rail and is capable of being able to maintain said rail directly and rigidly relative to the structural frame.

As a result, the positioning of a mounting device according to the invention is particularly simple. In particular, the fixing of the attachment clamps on the structural frame is carried out in a first step; in a subsequent step, the rails are inserted into the means for receiving the rails of said attachment clamps; then the fixing holders are assembled to the rails; then the fixings are anchored in said fixing holders; and in a subsequent step, the equipment is fixed into said fixings.

A rail of an intermediate frame according to the invention may have various shapes and dimensions.

There is nothing to prevent a rail of said intermediate frame—in particular each rail of said intermediate frame—from having a symmetry of revolution. Such a rail is, in fact, easy to insert into the attachment clamps by a human operator, said operator not having to be concerned by the orientation of said rail. This variant has, however, the drawback of making it more complicated to achieve a blocking in rotation of the fixing holders relative to the rail about its longitudinal axis.

Thus, preferably, advantageously and according to the invention, at least one rail of said intermediate frame—in particular each rail—is not symmetrical in revolution.

Advantageously, and according to the invention, at least one rail—in particular each rail—has a straight cross section of which the peripheral contour has at least one straight portion.

Advantageously and according to the invention, at least one rail of said intermediate frame—in particular each rail of said intermediate frame—has a straight cross section of which the peripheral contour is polygonal—in particular square.

A rail formed by a tube of square straight cross section is particularly suitable for producing an intermediate frame.

A rail according to the invention may be provided in a metallic material, in a composite material containing carbon or in an equivalent material.

Advantageously and according to the invention, said intermediate frame further comprises rail connectors capable of rigidly connecting two adjacent rails to one another.

An intermediate frame comprising rails and rail connectors permits the production of a wide variety of configurations. Moreover, such a frame may consist of rails of different lengths according to the zones of the structural frame to be covered and according to the distance between two attachment clamps. Rail connectors also make it possible to join a plurality of rails end to end, to extend between two attachment clamps.

The rail connectors may be selected from the group formed by straight rail connectors intended to connect two rails in a coaxial manner in line with one another; right-angled rail connectors to connect two rails perpendicularly to one another; oblique rail connectors making it possible to arrange two rails relative to one another at a pre-determined angle.

Rail connectors according to the invention also make it possible to produce an intermediate frame which extends over a plurality of planes.

Each element of the intermediate frame is capable of receiving, at an infinite number of assembling sites, at least one fixing holder, said fixing holder being capable of bearing at least one fixing for at least one piece of non-dimensioning equipment, in particular network equipment.

The assembly between a fixing holder and an intermediate frame element, in particular a rail for receiving a fixing holder may be produced by various rigid assembly means, such as assembly means of the screw-nut type, peg and hole assembly means, means using clamping ring(s), magnetized means, adhesive means, etc.

The assembly means may be means which require, or do not require, the use of a tool. Advantageously, said means are capable of being able to permit the assembly of a fixing holder to a rail without the use of a tool so as to facilitate mounting in the factory.

According to a variant of the invention, an intermediate frame member, in particular a rail for receiving fixing holders, may comprise, in addition to the sites for receiving fixing holders having a resilient clip, a pre-determined set of assembling sites uniformly distributed along this rail, such as apertures intended to receive screws, or holes intended to receive a peg of a fixing holder, etc. According to this embodiment, a fixing holder comprises a screw intended to be housed in the corresponding aperture of the rail or a peg intended to cooperate with a hole formed in a rail, etc.

In the case where the intermediate frame comprises rails of square straight cross section, advantageously and according to the invention, said resilient clip of a fixing holder comprises two resiliently flexible walls, parallel to one another and spaced apart from one another by a dimension slightly less than the dimension of one side of the square of the straight cross section of these rails, so that said fixing holder may grip a rail of square straight cross section at any point of the rail and prevent any undesired movement of the fixing holder along the rail, once fixed thereto.

A fixing holder comprising a resilient clip makes it possible in a simple and rapid manner to fix a fixing holder to a rail or to displace said fixing holder along the rail or to disconnect said fixing holder from the rail. Moreover, a rail having a square cross section capable of receiving a resilient clip comprising two parallel walls, spaced apart from one another, of a dimension slightly less than the dimension of one side of this square, may receive this clip on one of its four sides, thus providing a wide variety of assembly options.

Such a fixing holder may be formed from any type of material—metallic, composite, polymer, etc.

The dimensions of the resilient clip are capable of gripping the receiving rail, once mounted on the rail. As a result, once mounted on the rail, the fixing holder is not susceptible to undesired movement along the rail or around the rail.

However, with the purpose of guaranteeing that a fixing holder according to the invention may not be disconnected from the rail in an untimely manner, advantageously and according to the invention, at least one fixing holder—in particular each fixing holder—comprises a locking fastener capable of covering the clip, which forms a spring, of said fixing holder such that said fixing holder may entirely grip the rail to which it is fixed, thus preventing any dislodging of said fixing holder from the rail.

According to a variant of the invention, a fixing holder comprises means for the identification of the assembling site of the intermediate frame where said fixing holder has to be positioned. These identification means make it possible to facilitate the work of a human operator who has to arrange the fixing holders on the rails of the intermediate frame. These identification means of the assembling site may be of any type. They may be optical identification means directly readable and comprehensible by a human operator, such as the coordinates (x, y, z) of the assembling site; coded optical means, representing an assembling site and capable of being read and interpreted by a machine, such as bar codes, dot matrices, etc.; or contactless identification means of the RFID type; etc.

As a variant or in combination, said identification means may be arranged on the intermediate frame so that an operator may take any fixing holder and arrange it on the intermediate frame at a preferred assembling site identified by said identification means. In this case, said identification means are preferably visual means, easily identifiable by the operator.

Such a device makes it possible, therefore, to define the desired configuration before its installation on the structural frame, which permits subsequent rapid and simple mounting. The visual identification means facilitate the work of assembly operators. This being the case, if a change of configuration is required, including after the end of the initial assembly, this change is possible as each fixing holder is removable and able to be fixed at a different point of a rail of the intermediate frame. The identification means previously associated with the initial position may thus be removed from the rail so as not to cause an operator, who would see an identification means on the rail which does not comprise a fixing holder, to make an error. To achieve this, said identification means are preferably removable adhesive labels.

Each fixing holder bears at least one fixing for at least one piece of network equipment. A fixing holder and a fixing may be formed from a single part or may be formed from a set of parts.

According to a variant of the invention, a fixing holder has at least one anchoring point and bears one fixing per anchoring point. For example, this anchoring point may be created by forming an orifice or a threaded hole intended to receive fixing elements such as screws or screw-nuts so as to permit the anchoring of a fixing to the fixing holder.

According to the invention, the fixings of a piece of non-dimensioning equipment—in particular network equipment—may be of any type. These fixings may be staples, loops, collars, buttons, hooks, pins, Velcro systems, compression systems, etc. A fixing may be specific to each type of equipment, or permit the support of a variety of pieces of equipment.

Similarly, a fixing holder may be associated with a specific fixing or accommodate a variety of different fixings.

The fixing of the intermediate frame to the structural frame is implemented by means of attachment clamps anchored in the structure in the region of fixing sites.

Said attachment clamps are anchored to the structural frame by means of any type of fixing means, such as for example means of the screw-nut type.

Said attachment clamps may also have different shapes and dimensions.

Said clamps are selected from a set of clamps which are pre-determined and of limited number. According to a variant of the invention, the sites for fixing the clamps are thus all identical, which facilitates the design of the structural frame of the vehicle.

Advantageously and according to the invention, at least one attachment clamp—in particular each attachment clamp—for said intermediate frame on said structural frame of the vehicle comprises a rigid bar extending in one direction, known as the longitudinal direction, comprising:
a series of bores arranged in the longitudinal direction, each bore being capable of permitting the passage of fixing means of the screw-nut type so as to ensure the fixing of said fixing bar to said structural frame,
a plurality of through-housings for receiving made in said bar, extending in a direction perpendicular to said longitudinal direction, each receiver housing having a straight cross section which is shaped and conjugate with the straight cross section of the rails of the intermediate frame so that each housing for receiving each bar may receive at least one fixing rail.

According to this variant of the invention, an attachment clamp comprises a bar extending in a longitudinal direction and having a straight longitudinal cross section in the form of notches. Each notch forms a housing for receiving at least one rail.

The bar has a series of bores arranged in the longitudinal direction, each bore extending over the height of the bar and being capable of permitting the passage of fixing means of the screw-nut type so as to ensure the fixing of this fixing bar to said structural frame.

According to this variant, advantageously and according to the invention, at least one fixing bar—in particular each fixing bar—comprises a bridging part capable of being housed on said fixing bar in order to prevent any untimely dislodging of the fixing rails from the receiver housings.

This bridging part makes it possible to cover the notches which limits the undesired movements of the rails in a direction at right angles to the axis of these rails.

Advantageously and according to the invention, at least one fixing bar—in particular each fixing bar—comprises a projection made in at least one housing for receiving said bar so as to fill the production tolerances of the rails and the fixing bars.

Such a projection makes it possible to limit the clearance between a rail housed in a housing for receiving a fixing bar and said fixing bar.

This projection may be made in the vicinity of a lateral edge of the bar or equidistant between the two lateral edges of the bar.

The different elements of a mounting device according to the invention may be made from various materials, such as metallic materials, polymeric materials, composite materials, etc.

A device according to the invention makes it possible to support any types of non-dimensioning equipment relative to the structural frame of the vehicle.

In practice, a mounting device according to the invention is particularly designed for positioning in a vehicle equipment of an electrical network, equipment of a pneumatic network, equipment of a hydraulic network, or equipment of a mixed electrical, pneumatic and hydraulic network.

The invention extends to a vehicle provided with a mounting device according to the invention.

In particular, the invention relates to an aircraft provided with a mounting device according to the invention, a high speed train provided with a mounting device according to the invention and generally a vehicle comprising a structural frame comprising a plurality of fixing sites for attachment clamps formed uniformly on the structural frame.

To achieve this, the invention relates to an aircraft comprising an aircraft airframe, wherein said aircraft airframe comprises:
a plurality of fixing sites uniformly distributed over said airframe, each fixing site being capable of receiving fixing means for a rigid attachment clamp of a mounting device according to the invention so as to be able to ensure the fixing of said attachment clamp to said airframe.
at least one mounting device for non-dimensioning equipment according to the invention, said mounting device being fixed rigidly to said airframe in the region of at least one fixing site.

The invention also extends to a method for mounting network equipment on a structural frame of a vehicle.

To achieve this, the invention also relates to a method for mounting non-dimensioning equipment on a structural frame of a vehicle, wherein:
fixing sites are made on said structural frame of the vehicle and uniformly distributed over said frame, each fixing site being capable of receiving at least one attachment clamp,
rigid attachment clamps are fixed to said structural frame in the region of a set of fixing sites, each attachment clamp being capable of receiving a portion of an intermediate frame and maintaining the same rigidly in order to prevent any undesired movement of said intermediate frame portion relative to the structural frame,
a rigid intermediate frame is arranged opposite a portion of said structural frame and portions of said intermediate frame are housed in said attachment clamps, said intermediate frame comprising a set of rigid assembling sites for a fixing holder on said intermediate frame,
fixing holders are assembled to said intermediate frame in the region of a set of said assembling sites, each fixing holder bearing at least one fixing for at least one piece of non-dimensioning equipment,
non-dimensioning equipment is housed in said fixings borne by said fixing holders.

A mounting method according to the invention is advantageously implemented by means of, and in, a mounting device according to the invention.

A mounting device according to the invention advantageously implements a mounting method according to the invention.

The invention relates to a device for mounting non-dimensioning equipment—in particular network equipment—, a vehicle provided with a device for mounting non-dimensioning equipment—in particular network equipment—and a method for mounting non-dimensioning equipment—in particular network equipment—characterized in combination by all or some of the features mentioned above or below.

Further features, objects and advantages of the invention will appear from reading the following description which presents by way of non-limiting example an embodiment of the invention, with reference to the accompanying drawings; in which:

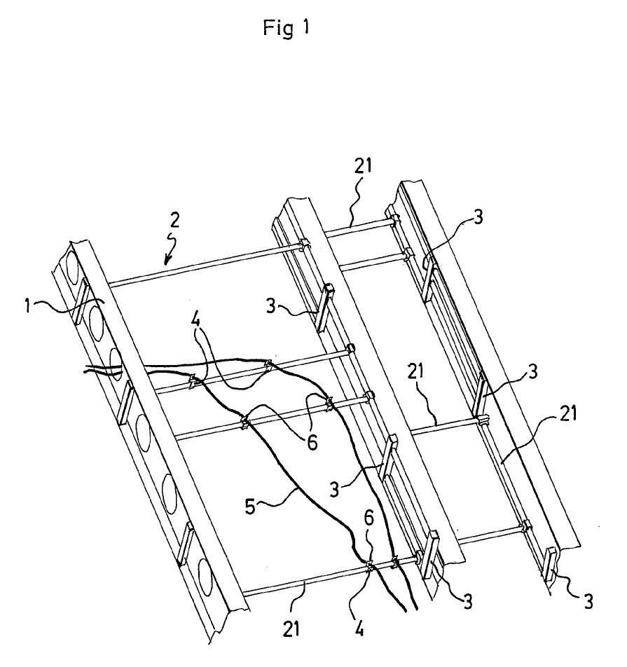

FIG. 1 is a schematic perspective view of a portion of a device for mounting non-dimensioning equipment according to an embodiment of the invention on a floor frame of an aircraft,

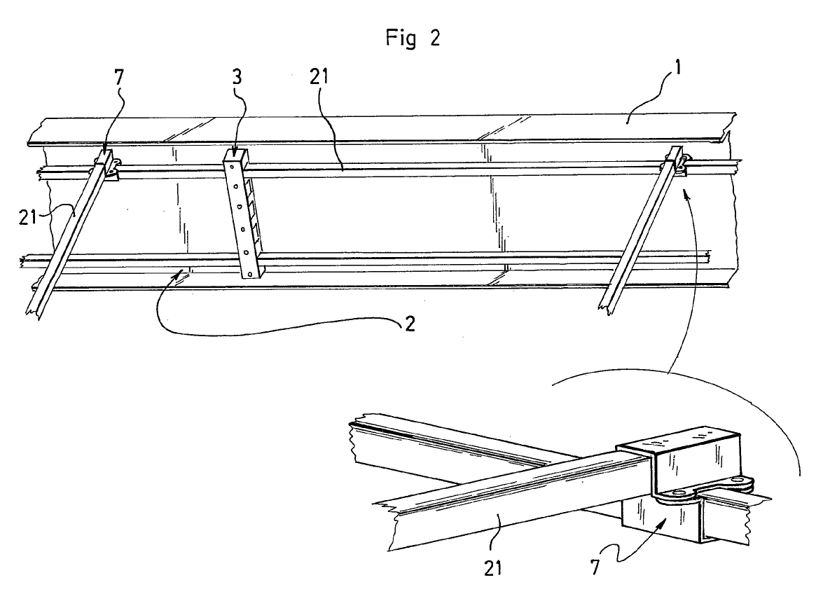

FIG. 2 is a schematic perspective view of a portion of a device for mounting non-dimensioning equipment according to an embodiment of the invention on a floor frame of an aircraft comprising two rails according to an embodiment of the invention arranged at right angles relative to one another and connected by a rail connector according to an embodiment of the invention,

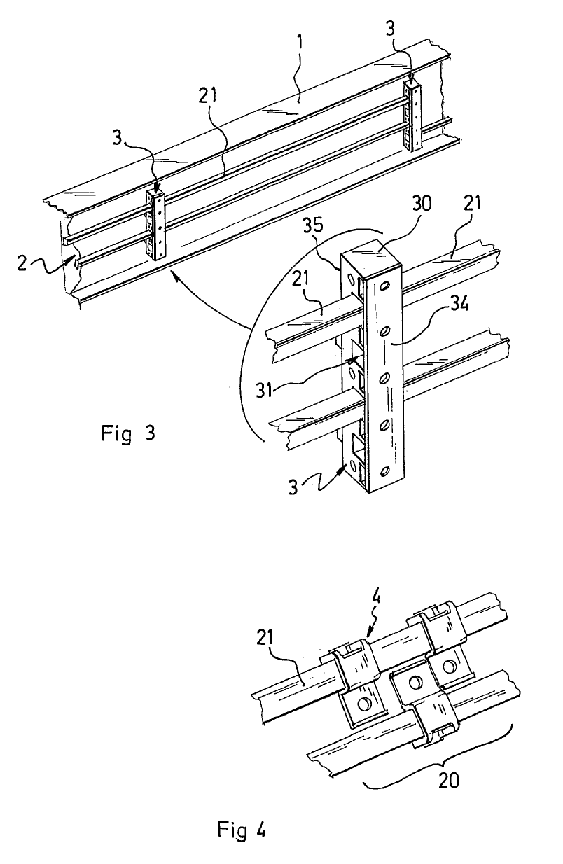

FIG. 3 is a schematic perspective view of an attachment clamp according to an embodiment of the invention comprising four housings for receiving a rail according to an embodiment of the invention, of which two respectively support a rail,

FIG. 4 is a schematic perspective view of two rails according to an embodiment of the invention bearing fixing holders according to an embodiment of the invention,

FIG. 5 is a schematic perspective exploded view of a fixing holder according to an embodiment and a fastener according to an embodiment of the invention,

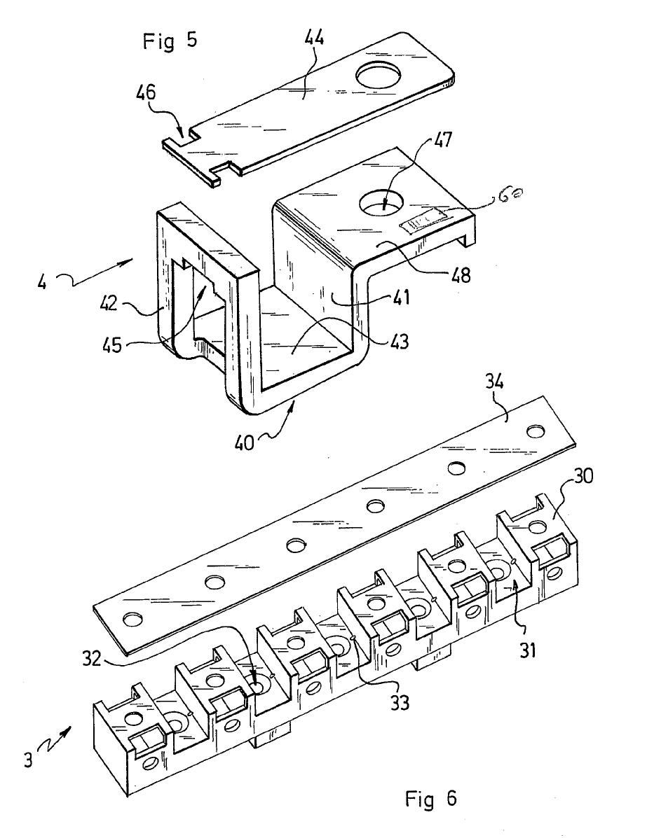

FIG. 6 is a schematic perspective view of a fixing bar for an intermediate frame on a structural frame according to an embodiment of the invention and a bridging part according to an embodiment of the invention,

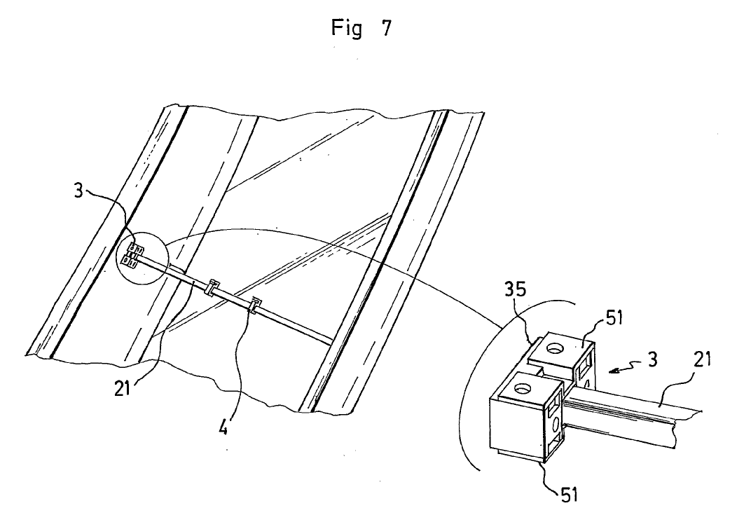

FIG. 7 is a schematic perspective view of a portion of a mounting device according to an embodiment of the invention comprising a rail housed in a fixing bar at right angles to the face of the bar in contact with the wall of the structural frame,

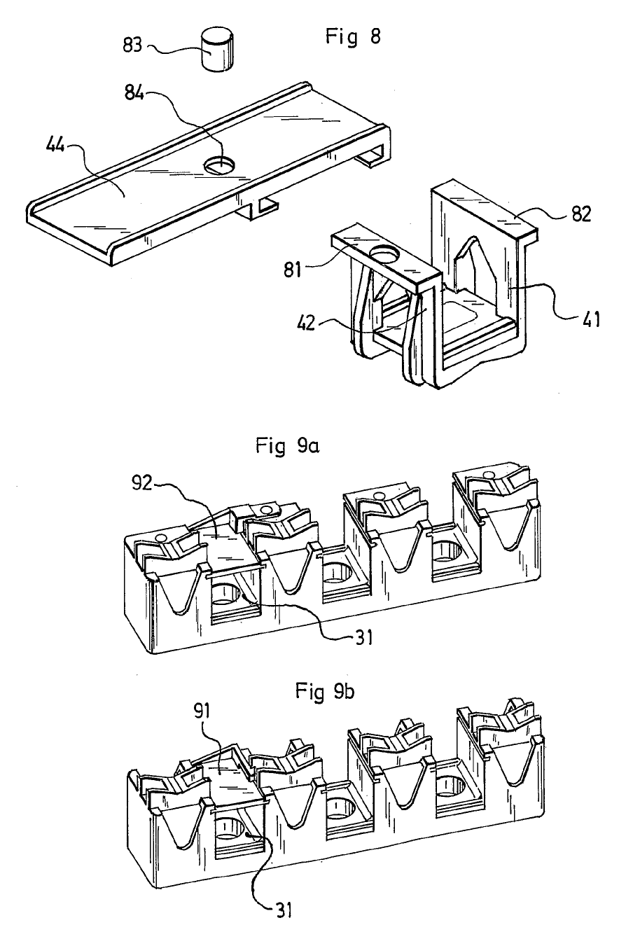

FIG. 8 is a schematic perspective view of a fixing holder according to a further embodiment,

FIGS. 9a and 9b are schematic perspective views of a fixing bar for an intermediate frame on a structural frame and bridging parts according to a further embodiment of the invention,

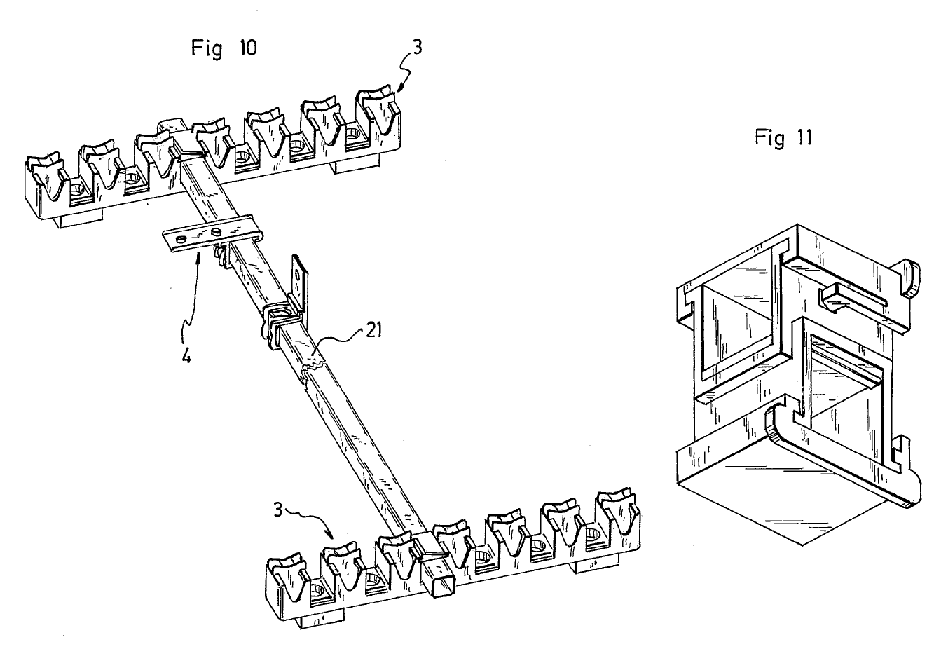

FIG. 10 is a schematic perspective view of a portion of a device for mounting non-dimensioning equipment according to a further embodiment of the invention,

FIG. 11 is a schematic perspective view of a rail connector according to an embodiment of the invention.

According to the invention and as shown in particular in FIG. 1, a device for mounting equipment 5 of a network to a structural frame 1 of a vehicle comprises a rigid intermediate frame 2, a plurality of rigid attachment clamps 3 for said intermediate frame 2 on said structural frame 1 of the vehicle, a plurality of fixing holders 4 assembled onto the intermediate frame 2 in a set of rigid assembling sites 20, and a plurality of fixings 6 for at least one piece of non-dimensioning equipment 5, such as electrical network equipment, each fixing 5 being borne by a fixing holder 4.

The intermediate frame 2 may be formed by various parts having various shapes and structures. It may, for example comprise plates, grids, panels, metal plates, trusses, rods, tubes, cables, mesh, etc., borne by the attachment clamps 3 and extending opposite the structural frame 1 in one or more directions.

According to a preferred embodiment, and as shown in FIGS. 1 to 4, the intermediate frame 2 comprises a plurality of rails 21 for receiving fixing holders 4. Each rail 21 is capable of receiving, at a plurality of points of the rail forming the assembling sites 20, at least one fixing holder 4 with the assembly means of this fixing holder 4 on the rail 21 adapted so that the fixing holder 4 may not be spontaneously displaced along the rail 21, nor around said rail once assembled to the rail 21.

To achieve this, and according to the preferred embodiment shown in the figures, the rails 21 are formed by rigid tubes made of metallic material or composite material of square straight cross section. The rails 21 may have different lengths, for example of between 5 mm and 10 metres. A rail 21 may be rectilinear or curved over a radius of 100 mm to 10 metres, or the like.

As shown in FIG. 5, each fixing holder 4 comprises a clip returned elastically into the clamping position, known as a resilient clip 40, capable of permitting the fixing of said fixing holder 4 to the rail 21. This resilient clip 40 has two resiliently flexible walls 41, 42, parallel to one another and spaced apart from one another by a dimension slightly less than the dimension of one side of the square of the straight cross section of a square rail, so that said fixing holder 4 may grip the rail 21 at any point of the rail 21, and prevent any undesired movement of the fixing holder 4 along the rail 21, once fixed thereto.

A device according to the invention permits a human operator responsible for mounting non-dimensioning equipment 5 on an intermediate frame 2, to have an infinite number of positions for assembling a fixing holder 4 to a rail 21. More specifically, a resilient clip 40 of a fixing holder 4 may be fixed at any point of the rail 21, along the rail. A device according to the invention thus permits a high degree of flexibility for mounting non-dimensioning equipment 5 on the intermediate frame 2 which permits, in particular in the assembly shop, to select a mounting of the equipment 5 which may, for example, tolerate stresses not initially predicted.

According to an advantageous embodiment of the invention, and as shown in FIG. 5, a fixing holder 4 comprises means of identification of the assembling site of the intermediate frame where said fixing holder has to be positioned. These identification means make it possible to facilitate the work of a human operator who has to arrange the fixing holders on the rails of the intermediate frame. These identification means of the assembling site may be of any type. They may be optical identification means directly readable and comprehensible by a human operator, such as the coordinates (x, y, z) of the assembling site; coded optical means representing an assembling site and capable of being read and interpreted by a machine, such as bar codes, dot matrices, etc; or contactless identification means of the RFID type, etc.

According to the embodiment of FIG. 5, said identification means comprise a bar code 60. Said bar code 60 may, for example, be interpreted by a portable machine to provide an operator with the coordinates (x, y, z) of the assembling site, at which it has to be assembled, or a graphical representation displayed on a screen of a portable machine of the assembling site at which it has to be assembled.

The relation between the bar codes 60 and assembling sites is preferably established on plan by computer means, prior to the mounting of the device. Said computer means may be incorporated in the portable machine or stored on a server accessible remotely from the portable machine.

According to a further embodiment of the invention, said identification means are directly arranged on the rails of the intermediate frame.

FIG. 4 has two rails 21 housed in an attachment clamp 3, each rail bearing at least one fixing holder 4, each fixing holder 4 comprising a resilient fixing clip capable of allowing the assembly between the fixing holder 4 and a rail 21.

A resilient clip 40 of a fixing holder 4 may be formed in various materials. However, according to a preferred embodiment of the invention, the resilient clip 40 is made from a material containing carbon. This makes it possible to confer to the resilient clip 40 the properties of flexional elasticity.

According to further embodiments, not shown in the figures, the rails 21 and the fixing holders 4 may have other conjugate shapes and dimensions. For example, a rail 21 may have a straight cross section, of which the peripheral contour only has one straight portion, or even none. A rail of which the straight cross section has a symmetry of revolution, nevertheless has the drawback of making it more complicated to achieve a blocking in rotation of the fixing holders relative to the rail.

According to the embodiment of FIG. 5, the resilient clip 40 comprises a wall 43 at right angles to the flexible walls 41, 42. Once assembled to a parallelepiped rail 21, of square straight cross section, the walls 41, 42, 43 are respectively in contact with three of the four longitudinal external faces of the rail 21.

According to a preferred embodiment of the invention, and as shown in FIG. 5, a fixing holder 4 comprises a locking fastener 44 capable of locking the resilient clip 40 to the rail 21, extending parallel to the wall 43 and at right angles to the flexible walls 41, 42, so that a resilient clip provided with the locking fastener 44 completely grips the rail 21. In other words, the locking fastener 44 covers the parallelepiped face of the rail 21 of square straight cross section which is not in contact with one of the walls 41, 42, 43 of the resilient clip 40.

This locking fastener 44 comprises means for assembly to a flexible wall of the resilient clip 40. For example, and as shown in FIG. 5, a flexible wall 42 comprises an opening 45 capable of permitting the passage of one end portion 46 of the locking fastener 44. This end portion 46 of the locking fastener 44 has a shape and dimensions capable of allowing the housing of this end portion 46 in the opening 45 of the wall 42 and the gripping of this end portion 46 in the wall 42.

According to the invention, a fixing holder 4 bears at least one fixing 6 for at least one piece of equipment 5.

According to the embodiment of the figures, a fixing holder 4 and a fixing 6 are two separate parts and the fixing holder 4 comprises an anchoring point for said fixing 6 on the fixing holder 4. This anchoring point is, according to the embodiment of the figures, produced by a through-aperture 47 of circular contour made on an arm 48 of the resilient clip 40. This aperture 47 is capable of receiving a fixing 6, for example a fixing 6 comprising a resilient portion having a shape and dimensions shaped and conjugate with the shape and dimensions of the aperture 47, so as to permit the fitting of the resilient portion in the aperture 47.

The arm 48 in which the aperture 47 is made is preferably borne by one of the flexible walls 41, 42 and extends at right angles to these walls. According to the embodiment of FIG. 5, this arm 48 is borne by the flexible wall 41. According to the embodiment of FIG. 5, the locking fastener 44 extends, once housed in the flexible wall 42, opposite the wall 41, above the arm 48 and parallel thereto. As a result, to facilitate the anchoring of a fixing 6 to the clip 40, the fastener 44 may comprise an opening coaxial with the aperture 47 for anchoring the arm 48. Thus, a fixing 6 is anchored both in the locking fastener 44 and in the resilient clip 40.

According to this embodiment, the arm 48 is parallel to the axis of the rail 21 once the fixing holder 4 is assembled to the rail 21.

A fixing according to the invention may have various forms. A fixing according to the invention may be a staple, a loop, a collar, a button, a hook, a pin, a pair of straps with hooks and loops (Velcro®) or press studs, etc. A fixing may be specific to each type of equipment, or permit the support of a variety of equipment.

According to an embodiment of the invention, a fixing 6 comprises a peg, having a shape and dimensions conjugate with the shape and dimensions of at least one hole formed in at least one fixing holder 4, so as to be able to be housed in said fixing holder by said peg being fitted into said hole and held rigidly thereby.

According to a further embodiment shown in FIG. 8, the flexible wall 41 of a fixing holder has a flange 81 substantially perpendicular to this wall 41 and extending away from the flexible wall 42 opposite. Similarly, the flexible wall 42 has a flange 82 substantially perpendicular to this wall 42 and extending away from the flexible wall 41 opposite. The shapes and dimensions of the grooves of the fastener 44 and of the flanges of the fixing holder are shaped and conjugate such that the fastener 44 may be slid into the flanges 81, 82 and thus close the fixing holder and prevent any undesired movement of the fixing holder from the rail (not shown in FIG. 8 for the purposes of clarity).

Moreover, according to the embodiment of FIG. 8, the blocking of the fastener 44 may be secured by a rivet or a peg 83, for example made of plastics material, which is housed in holes 84 arranged respectively in the fixing holder and in the fastener 44.

Naturally, according to further embodiments, the blocking of the locking fastener 44 on the resilient clip 40, once said clip is fixed to a rail 21, may be implemented by other means, for example by means of the screw-nut type or others.

According to further embodiments, a fixing holder 4 and a fixing 6 may be formed in one piece.

FIG. 3 is a view of a detail of a mounting device according to the invention. In this view, rails 21 are housed in an attachment clamp 3.

According to the embodiment of the figures, an attachment clamp 3 for the intermediate frame 2 on the structural frame 1 of a vehicle comprises a bar 30 extending in one direction, known as the longitudinal direction. This bar 30 comprises a plurality of housings 31 for receiving a rail 21. These receiver housings are through-housings and are formed in the bar 30 extending in a direction perpendicular to the longitudinal direction.

Each housing 31 for receiving a rail 21 has a straight cross section which is shaped and conjugate with the straight cross section of a rail 21 of the intermediate frame 2 so that each housing 31 for receiving each bar 30 may receive at least one rail 21.

In FIG. 3, the bar 30 comprises four housings for receiving a rail 21, of which two are effectively occupied by a rail 21.

Bars 30 according to this embodiment make it possible to fix the intermediate frame 2 to the structural frame 1.

To achieve this, each bar 30 comprises, as shown in FIG. 6, a series of bores 32 distributed in the longitudinal direction. Each bore 32 extends perpendicular to the longitudinal direction of the bar 30 and is capable of permitting the passage of a screw or a bolt capable of ensuring the fixing of said fixing bar 30 to the structural frame 1.

In practice, the structural frame 1 comprises a plurality of fixing sites uniformly distributed over the entire structural frame 1, each fixing site being capable of receiving a fixing bar 30.

According to the embodiment of the figures, a bar 30 is notched and each notch forms a housing 31 for receiving at least one rail 21. According to one embodiment of the invention, and as shown in FIG. 7, a rail 21 may be housed in a notch such that one transverse end of this rail 21 abuts against the bottom of the notch. According to FIG. 7, a rail 21 is housed in a housing for receiving a bar 3, at right angles to the face of the bar 3, known as the mounting face 35, in contact with the structural frame 1. As a variant or in combination, and as shown in particular in FIG. 3, a rail 21 may be housed in an attachment clamp 3, parallel to the plane in which the mounting face 35 of said fixing bar 3 extends. An attachment clamp having such a notched bar permits a wide variation in the mounting of the rails, said rails being able to have different orientations relative to the bars.

According to a preferred embodiment of the invention, for each notch forming a housing 31 for receiving a rail 21, a bar 30 comprises at least one projection 33 formed equidistant from the two lateral edges of the bar 30 so as to fill the production tolerances of the rails 21 and of the fixing bars 30.

A bar 30 according to the invention may have a length of between 10 mm and 10 metres, a width of between 10 mm and 100 mm, and may be of rectilinear or curved shape. A bar 30 according to the invention may be hollow or solid.

A bar 30 according to the invention may be produced in a rigid metallic, composite or polymeric material.

Preferably, a bar 30 according to the invention is covered by a metallic sheet—in particular a titanium sheet—over its entire length, protruding solely from the bottom notched zones so as to permit the formation of potential starting points for metallization.

According to a preferred embodiment and as shown in FIGS. 3 and 6, an attachment clamp 3 also comprises a bridging part 34 capable of covering the notches forming the housings 31 for receiving rails 21 and preventing any dislodging of said rails from said notches in any direction at right angles to the axis of said rails. The fixing of a bridging part 34 to the bar 30 may be made by different means, such as assembly means using screws, pegs and holes, insert nuts, etc.

According to a preferred embodiment, a bar 30 comprises a plurality of orifices made on each of the faces which is not in contact with the structural frame, once this bar is fixed to the structural frame. Each bridging part also comprises a plurality of orifices, the distance between two orifices of a bridging part being equal to the distance between two orifices of one face of the bar. As a result, a bridging part may be formed on the bar so that at least two orifices of said bridging part are exactly opposite two orifices of one face of the bar. Said coaxial orifices may receive any type of fixing means capable of connecting rigidly said bridging part to said face of the bar. According to a preferred embodiment, the orifices of the bar or the orifices of the bridging part are provided with insert nuts, so as to facilitate the fixing operations of a bridging part to a face of a bar.

In the case where a rail 21 is mounted at right angles to the mounting face 35 of the attachment clamp 3 on the structural frame 1 and as shown in FIG. 7, two bridging parts 51 may be made on the longitudinal lateral edges of the bar 30 in order to prevent any dislodging of said rail from the notch in any direction at right angles to the direction of said rail 21. The fixing of a bridging part 51 to a face of the bar 30 may be obtained by the same means as the fixing of a bridging part 34 to the bar 30.

According to a further embodiment shown in FIGS. 9a and 9b, each notch 31 of a bar may be locked by a separate bridging part 91, 92. This separate bridging part 91, 92 makes it possible to secure the blocking of a rail housed in this notch 31. According to the embodiment of FIG. 9a, the blocking of the separate bridging part 91 is obtained by a lug, for example a lug made of plastics material. According to the embodiment of FIG. 9b, the blocking of the separate bridging part 92 is obtained by a resilient clip which is housed between two vertical walls borne by the bar and which prevents the movement of the separate bridging part 92 relative to the bar.

FIG. 10 shows a portion of a device according to the invention of which the bars are those of the embodiment of FIG. 9b and the fixing holders are those of the embodiment of FIG. 8.

A device for mounting equipment according to the invention may be fixed to any type of structure of any type of vehicle, and more particularly to motorized vehicles.

A device for mounting non-dimensioning equipment according to the invention is particularly intended to be fixed to a frame of an aircraft or a high speed train and in a general manner to a frame of a vehicle optimized in terms of weight and mechanical strength—in particular under fatigue.

The invention extends to a vehicle provided with such a mounting device.

According to an embodiment of the invention not shown in the figures, an aircraft comprises an aircraft airframe forming the structural frame of the aircraft. Said aircraft airframe is formed from members (side rails, crossmembers, joists, ribs, stiffeners, frames, stringers, etc.) assembled to one another—in particular by riveting and/or bonding and/or welding—each member being capable of bearing at least one piece of non-dimensioning equipment. Moreover, said aircraft airframe comprises a plurality of fixing sites uniformly distributed over the airframe. Each fixing site is capable of receiving fixing means for a rigid attachment clamp 3 for a mounting device according to the invention so as to be able to ensure the fixing of said attachment clamp 3 to the airframe.

An aircraft according to the invention also comprises a mounting device according to the invention fixed rigidly to the airframe in the region of at least one fixing site.

FIG. 3 shows, by way of non-limiting example, a portion of a mounting device according to the invention fixed to an aircraft floor. Said portion of the mounting device comprises a fixing bar 30 according to one embodiment of the invention in which a plurality of rails 21 are inserted for receiving fixing holders 4.

A rail 21 may extend integrally between two fixing bars 30 or be connected to a further rail 21 by means of a rail connector 7, said other rail being itself connected to a third rail or housed in a fixing bar. In other words, all combinations are possible.

According to a preferred embodiment, the intermediate frame 2 comprises a plurality of connectors 7 for rails 21 capable of rigidly connecting two adjacent rails 21 to one another.

Said rail connectors 7 may be of any type. They may permit a coaxial connection of two rails, a connection at right angles of two rails, or a connection at a pre-determined angle of two rails, etc.

In FIG. 2, two rails 21 are connected by means of a rail connector 7 which is capable of connecting two rails at right angles to one another.

According to this embodiment, the rail connector 7 is formed in two parts, each part having a U-shaped straight cross section, each limb of the U-shape being, moreover, provided with a lateral arm perpendicular to this limb. The distance between the two limbs of the U-shape is substantially equal to the dimension of one side of the straight cross section of a rail 21. Thus, a rail 21 may be longitudinally housed in such a part. Each arm of each part, moreover, comprises bores capable of receiving assembling means such as lugs. Thus, according to one embodiment, the two rails and the two parts are arranged such that the arms of the first part come into contact with the arms of the second part, which makes it possible to align the bores of the arms. It is possible to introduce assembly means into the aligned bores, for example using screws, to connect rigidly said two parts and also the two rails.

According to a further embodiment permitting a simpler assembly than the preceding embodiment, each U-shaped part comprises two insert nuts mounted in a staggered fashion. During mounting, the nuts of a U-shaped part are housed in the bore opposite the other U-shaped part, thus ensuring a rigid assembly between said two parts.

According to a further variant of the invention as shown in FIG. 11, the rail connectors have substantially the same shapes as the overall shape of a fixing holder, with the exception that the fastener does not have an arm provided with a bore intended to receive a fixing of a non-dimensioning element.

Naturally, rail connectors according to the invention may have different shapes and structures.

The invention also relates to a method for mounting non-dimensioning equipment on a structural frame of a vehicle.

According to one embodiment of the invention, fixing sites are formed on said structural frame of the vehicle and uniformly spaced apart on said frame, each fixing site being capable of receiving at least one attachment clamp.

Subsequently, rigid attachment clamps are then fixed to said structural frame in the region of a set of fixing sites, each attachment clamp being capable of receiving a portion of an intermediate frame and maintaining the same rigidly in order to prevent any undesired movement of said intermediate frame portion relative to the structural frame.

A rigid intermediate frame is then arranged opposite said structural frame and portions of said intermediate frame are housed in said attachment clamps, said intermediate frame comprising a set of rigid assembling sites for a fixing holder on said intermediate frame.

Fixing holders are then assembled to said intermediate frame in the region of a set of said assembling sites, each fixing holder bearing at least one fixing for at least one piece of non-dimensioning equipment.

Non-dimensioning equipment, for example network equipment, is then housed in said fixings borne by said fixing holders.

A method according to the invention makes it possible to fix equipment to a frame of a vehicle without requiring an exact knowledge, prior to the mounting of the equipment, of the configuration of this equipment.

The invention is not limited simply to the disclosed embodiments. In particular, a device for mounting equipment according to the invention may comprise further types of attachment clamp, a further type of intermediate frame, and further types of fixing holders, which also provides flexibility during the mounting of the equipment, simplicity during the design of the vehicle and a possibility of modifying the choices made without causing alterations to the aircraft.

1-18. (canceled)

19. A device for mounting non-dimensioning equipment on the structural frame of a vehicle, said device comprising:
a plurality of fixings for at least one piece of non-dimensioning equipment, each fixing being capable of receiving and maintaining at least one portion of non-dimensioning equipment,
wherein it comprises:
a rigid intermediate frame comprising a plurality of rigid assembling sites for at least one fixing holder on said intermediate frame,
a plurality of fixing holders bearing at least one fixing and comprising a clip returned elastically into the clamping position, known as a resilient clip, capable of permitting the fixing of this fixing holder at any one of the rigid assembling sites,
a plurality of rigid attachment clamps for securing said intermediate frame onto said structural frame of the vehicle, each attachment clamp being rigidly anchored on the structural frame and receiving at least one intermediate frame portion and maintaining the same rigidly in order to prevent any undesired movement of said intermediate frame portion relative to the structural frame.

20. The device as claimed in claim 19, wherein the number of assembling sites made on said intermediate frame is greater than the number of attachment clamps of the intermediate frame on the structural frame.

21. The device as claimed in claim 19, wherein said intermediate frame comprises a plurality of rails for receiving said fixing holders, each receiving rail being capable of receiving rigidly, at any point of the rail, at least one fixing holder.

22. The device as claimed in claim 21, wherein at least one attachment clamp comprises means for receiving at least one portion of a rail capable of receiving said rail and maintaining the same rigidly in order to prevent any movement of said rail relative to the structural frame of said vehicle.

23. The device as claimed in claim 21, wherein at least one rail of said intermediate frame—in particular each rail of said intermediate frame—is not symmetrical in revolution.

24. The device as claimed in claim 23, wherein at least one rail of said intermediate frame—in particular each rail of said intermediate frame—has a straight cross section of which the peripheral contour has a straight portion.

25. The device as claimed in claim 24, wherein at least one rail of said intermediate frame—in particular each rail of said intermediate frame—has a straight cross section of which the peripheral contour is polygonal—in particular square.

26. The device as claimed in claim 25, wherein said resilient clip of a fixing holder comprises two resiliently flexible walls, parallel to one another and spaced apart from one another by a dimension slightly less than the dimension of one side of the square of the straight cross section of a rail of square straight cross section, so that said fixing holder may grip the rail at any point of the rail and prevent any undesired movement of the fixing holder along the rail, once fixed thereto.

27. The device as claimed in claim 21, wherein at least one fixing holder—in particular each fixing holder—comprises a locking fastener capable of receiving the resilient clip of said fixing holder such that said fixing holder may entirely grip the rail to which it is fixed, thus preventing any dislodging of said fixing holder from the rail.

28. The device as claimed in claim 21, wherein said intermediate frame comprises rail connectors capable of rigidly connecting two adjacent rails to one another.

29. The device as claimed in claim 21, wherein at least one fixing for at least one piece of non-dimensioning equipment—in particular each fixing—comprises a peg having a shape and dimensions conjugate with the shape and dimensions of at least one hole formed in at least one fixing holder—in particular each fixing holder—so as to be able to be housed in said fixing holder by said peg being fitted into said hole and held rigidly thereby.

30. The device as claimed in claim 21, wherein at least one attachment clamp—in particular each attachment clamp—for said intermediate frame on said structural frame of the vehicle comprises a rigid bar extending in one direction, known as the longitudinal direction, comprising:
a series of bores arranged in the longitudinal direction, each bore being capable of permitting the passage of fixing means of the screw-nut type so as to ensure the fixing of said fixing bar to said structural frame,
a plurality of through-housings for receiving made in said bar, extending in a direction perpendicular to said longitudinal direction, each receiver housing having a straight cross section which is shaped and conjugate with the straight cross section of the rails of the intermediate frame so that each housing for receiving each bar may receive at least one rail.

31. The device as claimed in claim 30, wherein at least one fixing bar—in particular each fixing bar—comprises at least one bridging part capable of being housed on at least one portion of said fixing bar in order to prevent any untimely dislodging of the rails from the receiver housings.

32. The device as claimed in claim 30, wherein at least one fixing bar—in particular each fixing bar—comprises a projection made in at least one housing for receiving said bar so as to fill the production tolerances of a rail housed in said receiver housing and said fixing bar.

33. The device as claimed in claim 19, wherein said non-dimensioning equipment is selected from equipment of an electrical network, equipment of a pneumatic network, equipment of a hydraulic network, and equipment of a mixed electrical, pneumatic and hydraulic network.

34. The device as claimed in claim 19, wherein each fixing holder comprises means of identification of the assembling site of the intermediate frame where said fixing holder has to be positioned.

35. An aircraft comprising an aircraft airframe, wherein said aircraft airframe comprises:
a plurality of fixing sites uniformly distributed over said airframe, each fixing site being capable of receiving fixing means for a rigid attachment clamp for a mounting device as claimed in claim 19, so as to be able to ensure the fixing of said attachment clamp to said airframe,
at least one other mounting device for non-dimensioning equipment, said other mounting device being fixed rigidly to said airframe in the region of at least one fixing site.

36. A method for mounting non-dimensioning equipment on a structural frame of a vehicle, known as the structural frame, wherein:
fixing sites are made on said structural frame of the vehicle and uniformly distributed over said frame, each fixing site being capable of receiving at least one attachment clamp,
rigid attachment clamps are fixed to said structural frame in the region of a set of fixing sites, each attachment clamp being capable of receiving a portion of an intermediate frame and maintaining the same rigidly in order to prevent any undesired movement of said intermediate frame portion relative to the structural frame,
a rigid intermediate frame is arranged opposite said structural frame and portions of said intermediate frame are housed in said attachment clamps, said intermediate frame comprising a set of rigid assembling sites for a fixing holder on said intermediate frame,
fixing holders are assembled to said intermediate frame in the region of a set of said assembling sites, each fixing holder comprising a clip returned elastically to the clamping position, known as the resilient clip, capable of permitting the fixing of said support to the intermediate frame, the fixing holder bearing at least one fixing for at least one piece of non-dimensioning equipment,
non-dimensioning equipment is housed in said fixings borne by said fixing holders.
